(19) United States
(12) Patent Application Publication
(10) Pub. No.: US 2026/0368322 A1
(43) Pub. Date: Nov. 19, 2026

(54) COMPREHENSIVE MONITORING OF SCRIPTS FOR XSS BEHAVIORS IN A SANDBOX

(71) Applicant: Palo Alto Networks, Inc., Santa Clara, CA (US)

(72) Inventors: Haozhe Zhang, San Jose, CA (US); Qi Deng, Sunnyvale, CA (US); Qi Zhang, Saratoga, CA (US); Shengming Xu, San Jose, CA (US)

(21) Appl. No.: 19/211,814

(22) Filed: May 19, 2025

(51) Int. Cl. G06F 21/56; G06F 21/55

(52) U.S. Cl. CPC G06F 21/566; G06F 21/554; G06F 2221/033

(57) ABSTRACT

A script evaluation system instantiates a web browsing environment in a sandbox. The system hooks into functions that may be invoked to carry out XSS attacks and modifies get/set functions for designated properties of browser-accessible objects to monitor access to these properties. The system preprocesses each script designated for evaluation to remove any special characters that may result in syntax errors. The system populates each placeholder in a web page template(s) with the script (which may have been preprocessed) to generate a web page(s) that is rendered in the web browsing environment. The system dispatches various events to simulate user interaction with the web page(s) that may trigger execution of the script. The system provides a report indicating results of execution of the script within the sandbox environment, which indicate any invocations of the hooked functions, accesses to the designated properties, and/or results of dispatching the events.

### BACKGROUND

The disclosure generally relates to data processing (e.g., CPC subclass G06F) and to security arrangements for protecting computers, components thereof, programs or data against unauthorized activity (e.g., CPC subclass G06F 21/00).

OWASP (Open Web Application Security Project) describes Cross-Site Scripting (XSS) attacks as injection type attacks that inject malicious code into websites that are typically trusted or benign. Typically, a malicious actor will inject a client-side script into a web page sent to a different end user via a trusted/benign website. The victim end user's browser will execute the script since the browser receives the script from the trusted/benign website. The malicious script can access any cookies, session tokens, or other sensitive information retained by the browser and used with that website. Despite XSS attacks being present for many years, detection is still challenging, at least because minor variations in XSS evade signature-based detection. XSS attacks can be used to incur financial losses, compromise sensitive data, distribute malware deface websites, launch phishing campaigns, etc.

### BRIEF DESCRIPTION OF THE DRAWINGS

Embodiments of the disclosure may be better understood by referencing the accompanying drawings.

FIG. 1 is a conceptual diagram of comprehensive monitoring of behavior of a script in a sandbox.

FIG. 2 is a flowchart of example operations for preparing a secure, isolated environment for script monitoring.

FIG. 3 is a flowchart of example operations for monitoring behavior of a script in a secure, isolated environment.

FIG. 4 is a flowchart of example operations for preprocessing scripts designated for monitoring to prevent syntax errors.

FIG. 5 depicts an example computer system with a script sandboxing system.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

To overcome the limitations of pattern-based XSS detection, techniques for compressive monitoring of execution of scripts in a sandbox to identify behaviors potentially related to XSS are disclosed herein. A script sandboxing system (“the system”) instantiates a web browser instance in a secure, isolated sandbox environment. The system hooks into (e.g., registers callbacks for) a plurality of functions that may potentially be invoked by malicious scripts to carry out XSS attacks. The system also modifies getters and setters for a plurality of properties of browser-accessible objects, such as document and window objects, to allow for monitoring access to these properties by scripts executing in the sandbox.

Upon submission of a payload comprising a script designated for evaluation, the system preprocesses the script extracted from the payload to remove characters that may result in syntax errors when the extracted script is executed. The system is configured with or has access to one or more web page templates, where each web page template comprises one or more placeholders. The system populates each placeholder with the script (which may have been modified as a result of preprocessing). Populating the web page template(s) generates a web page(s) that can be rendered in the web browsing environment within the sandbox. Upon rendering of the web page(s) within the sandbox environment, invocation of any of the functions by the script triggers a corresponding one of the hooks to record the function invocation. Similarly, access to any of the properties within the sandbox (i.e., via a respective get and/or set method) triggers recording of the property access. While rendering the web page(s) alone may trigger behaviors of the script, some behaviors may be triggered by Document Object Model (DOM) events, such as those resulting from interaction with the rendered web page(s). Thus, the system also dispatches various events simulating user interaction to the web page(s) loaded in the sandbox, such as mouse and keyboard events, to simulate user interaction with the web page(s) that may trigger execution of the script. The system provides a report indicating results of execution of the script in the sandbox, which indicate if any of the hooked functions were invoked, if the script accessed any of the designated properties, and/or results of dispatching the user interaction simulation events. Behaviors of the script represented in the report can then be evaluated to determine if the script is malicious and related to XSS. These results can supplement verdicts given by inline XSS detectors, be used to evaluate performance of the XSS detectors, and/or leveraged to generate training data for training machine learning models for malicious script detection.

### Example Illustrations

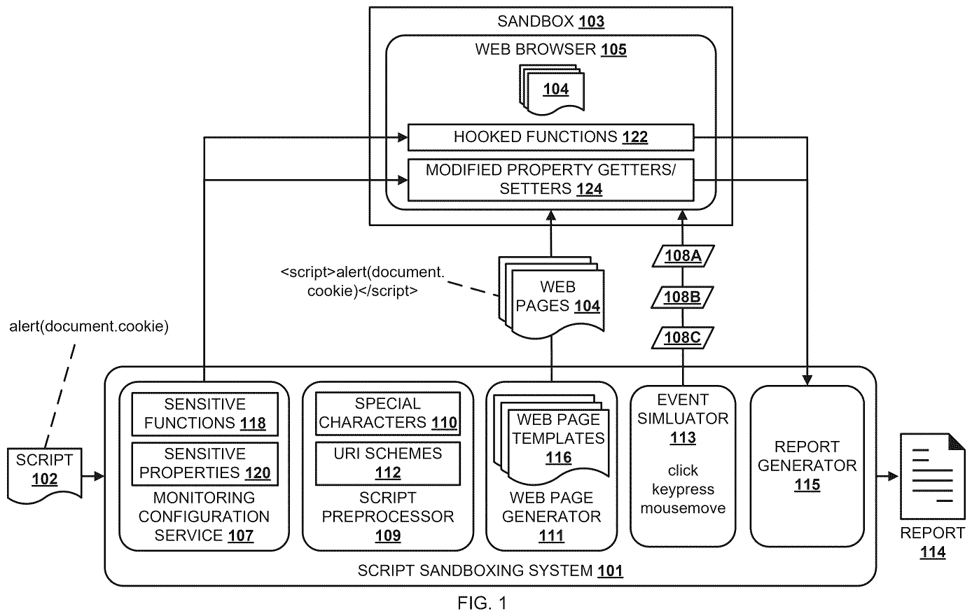

FIG. 1 is a conceptual diagram of comprehensive monitoring of behavior of a script in a sandbox. A script sandboxing system (“system”) 101 prepares a sandbox environment for monitoring execution of scripts to facilitate detection of malicious scripts related to XSS. The system 101 also generates web pages having scripts incorporated therein for rendering by a web browser executing in the sandbox environment. FIG. 1 depicts an example in which the system 101 obtains a script 102, depicted as an example script “alert(document.cookie)” written in the JavaScript® programming language, for monitoring in a sandbox environment. The script 102 may have been extracted from detected network traffic and designated to the system 101 for monitoring. The system 101 may obtain scripts such as the script 102 from a queue of scripts to be monitored, can act as a subscriber and obtain messages from a publisher with pub/sub messaging, or similar. While not depicted in FIG. 1 for simplicity, extraction of scripts from payloads, such as HyperText Transfer Protocol (HTTP) messages, may be performed by the system 101 or a component/entity with which the system 101 interfaces.

A monitoring configuration service (“service”) 107 of the system 101 instantiates a sandbox 103 and loads a web browser 105 in the sandbox 103. For instance, the system 101 can instantiate a secure, isolated environment (e.g., a virtual machine-based sandbox environment) intended for browser sandboxing and load the web browser 105 in the resulting sandbox. The system 101 can control the web browser 105 via an application programming interface (API) for this purpose, such as the API available via the Puppeteer JavaScript library or an API made available by another library (e.g., an open-source library).

The service 107 is configured with indications of sensitive functions 118 and sensitive properties 120. The sensitive functions 118 are functions that may be invoked by malicious scripts for carrying out an XSS attack. Examples of the sensitive functions 118 include the JavaScript functions “eval( )”, “alert( )”, “confirm( )”, and “prompt( )”. The sensitive properties 120 are properties of browser-accessible objects such as documents that malicious scripts may access (e.g., via getter and/or setter methods of the properties) for carrying out an XSS attack. Examples of the sensitive properties 120 include the HyperText Markup Language (HTML) document object properties “documentURI”, “baseURI”, “cookie”, and “referrer”. The sensitive functions 118 and sensitive properties 120 were previously determined based on expert/domain knowledge, research and experimentation, etc.

The service 107 creates a code hook for each of the sensitive functions 118 such that invocation of the sensitive functions 118 by scripts executed by the web browser 105 triggers program code for logging the function invocation. For instance, service 107 can “hooks into” (i.e., creates code hooks for) a JavaScript engine of the web browser 105. To create the code hooks, the service 107 can register a callback function for each of the sensitive functions 118, where invocation of the sensitive functions 118 triggers the corresponding callback function, which logs the invocation of the associated one of the sensitive functions 118. The service 107 also modifies getter and setter methods defined for each of the sensitive properties 120 such that access to any of the sensitive properties 120 via a respective getter and/or setter function results in logging of the get and/or set of the corresponding sensitive property. For instance, the service 107 can retrieve definitions of the “get( )” and “set( )” methods for each of the sensitive properties 120 and modify the definitions to incorporate a call to a logging function of the service 107 that logs the “get( )” or “set( )” invocation (e.g., via the “Object.getOwnPropertyDescriptor( )” and “Object.defineProperty( )” methods). FIG. 1 depicts the web browser 105 as comprising hooked functions 122 and modified property getters/setters 124 to represent creation of code hooks for the sensitive functions 118 and modification of getters and setters for the sensitive properties 120, respectively.

A script preprocessor 109 of the system 101 preprocesses scripts before they are loaded into the web browser 105 for execution and monitoring. The script preprocessor 109 is configured with one or more special characters 110, such as closing brackets, closing braces, and/or closing parenthesis. If the script preprocessor 109 determines that a script comprises any of the special characters 110 without a corresponding match (e.g., comprises a closing parenthesis without a corresponding opening parenthesis), the script preprocessor 109 removes the character(s) from the script. Removal of special characters from the beginning of scripts prevents syntax errors that may result from special characters being included in scripts that were included in network traffic payloads (e.g., HTTP message) comprising scripts that include partial JavaScript statements. In this example, the script 102 does not begin with any of the special characters 110, so the script preprocessor 109 does not remove any characters therefrom.

The script preprocessor 109 also maintains one or more indication of uniform resource identifier (URI) schemes 112 that may be included in malicious scripts for XSS attacks. The URI schemes 112 can include URI schemes registered with the Internet Assigned Numbers Authority (IANA), such as “http” and “https”, and/or URI schemes that are common but not registered with the IANA, such as “javascript”. If any of the URI schemes 112 are identified in a script, the script preprocessor 109 adds an indication of the URI scheme to a report generated for the script. Since none of the URI schemes 112 are included in the script 102 in this example, the script preprocessor 109 determines that the script 102 does not include any URI schemes of note.

A web page generator 111 of the system 101 incorporates scripts into web page templates to create web pages that can be rendered by the web browser 105. The web page generator 111 is configured with or has access to one or more web page templates 116, such as HTML templates, where each web page template includes one or more placeholders for scripts designated for monitoring. The web page templates 116 can include placeholders for scripts within various HTML elements, such as within body elements, table elements, and data elements, among others. The web page templates 116 are minimal in content such that execution of scripts, loading of content, etc. can be solely attributed to scripts being monitored (rather than attributable to various web page elements). The web page generator 104 incorporates the script 102 into each placeholder identified in the web page templates 116 to generate corresponding web pages 104. The web pages 104 comprise complete HTML files, each of which comprises the script 102. FIG. 1 depicts an example of a first of the web pages 104 as including the script 102 in a script element of the web page (i.e., “<script>alert(document.cookie)</script>”). While not depicted in FIG. 1 for simplicity, the script element may be nested within another HTML element.

The web page generator 111 provides the web pages 104 to the sandbox 103 for rendering by the web browser 105. For instance, the web page generator 111 can store the web pages 104 in a designated storage location accessible to the web browser 105 such that the web browser 105 can retrieve the web pages 104. The web page generator 111 can open a plurality of tabs within the web browser 105 via the API leveraged for controlling the web browser 105 and open each of the web pages 104 within a respective one of the tabs (e.g., via the Page class of Puppeteer). The web browser 105 renders the web pages 104, which may result in execution of the script 102 for one or more of the web pages 104. Any invocations of the sensitive functions 118 by the executing script 102 will trigger a respective one of the function hooks 122, which results in the system 101 logging the function invocation. Similarly, access to any of the sensitive properties 120 by the executing script 102 will trigger logging of the property access as a result of invocation of a corresponding one(s) of the modified property getters/setters 124.

An event simulator 113 of the system 101 simulates events (such as DOM events, sometimes referred to as “synthetic events”) for the web pages 104 to simulate user interaction with web page elements that may trigger script execution. The system 101 creates and dispatches events targeting elements of each of the web pages 104 to simulate interaction with the targeted element. For instance, the system can dispatch created events by calling “dispatchEvent( )”. Each dispatched event can indicate an element of the web pages 104 as an event target. For instance, the event simulator 113 can traverse the DOM generated for each of the web pages 104 and, for at least a subset of elements represented by nodes in the DOM identified from the traversal, dispatches one or more events targeting the element. Examples of DOM events include mouse events (e.g., “click”, “mousedown”, “mouseover”), keyboard events (e.g., “keydown”, “keypress”), clipboard events (e.g., “cut”, “copy”, “paste”), scroll/resize events, and media events. For elements identified from the DOM traversal that define an inline event handler, such as an inline event handler for “onclick” events, the event simulator 113 invokes the inline event handler(s) after dispatching the event(s0 targeting the element. This example depicts the event simulator 113 as dispatching events 108A, 108B, 108C targeting elements of each of the web pages 104, where the events 108A-C correspond to “click”, “keypress”, and “mousemove” events. Dispatching the events 108A-C may trigger execution of the script 102 in one or more of the web pages 102, which may in turn result in invocation of one or more of the sensitive functions 118 and/or access to one or more of the sensitive properties 120.

A report generator 115 of the system 101 generates a report 114 indicating results of monitored execution of the script 102 in the sandbox 103. The report generator 115 generates a report indicating invocations of any of the sensitive functions 118 and access to any of the sensitive properties 120 that were captured during execution of the script 102. The system 101 also includes in the report 114 an indication of whether the script 102 included any of the URI schemes 112 (which were not identified in the script 102 in this example). The report generator 115 can generate the report 114 in a specified format, such as JavaScript Object Notation (JSON), where the report format is indicated in a configuration of the report generator 115. The report generator 115 can indicate the report 114 (e.g., via a user interface), store the report in a database, etc.

While not depicted in FIG. 1, the report 114 can be leveraged to evaluate performance of XSS detectors, particularly those deployed for inline network traffic analysis. Inline XSS detectors detect malicious scripts in network traffic, such as network traffic detected at a firewall at which the inline XSS detectors execute and/or with which the inline XSS detectors communicate. Evaluation of script behavior reflected in the report 114 (e.g., evaluation by experts and/or another offline system for network traffic analysis) informs a verdict of whether each analyzed script is indeed a malicious script for XSS, which provides a ground truth against which to compare a verdict generated by an inline XSS detector. Inline XSS detectors can thus be refined for improved performance based on script behavior observed as a result of sandboxing for secure monitoring by the system 101. Alternatively, or in addition, scripts can be labeled as malicious/XSS related or benign based on evaluation of their corresponding reports generated by the system 101. The labeled scripts are then included in a set of training data used to train a machine learning model(s) (e.g., a classifier) to detect scripts related to XSS.

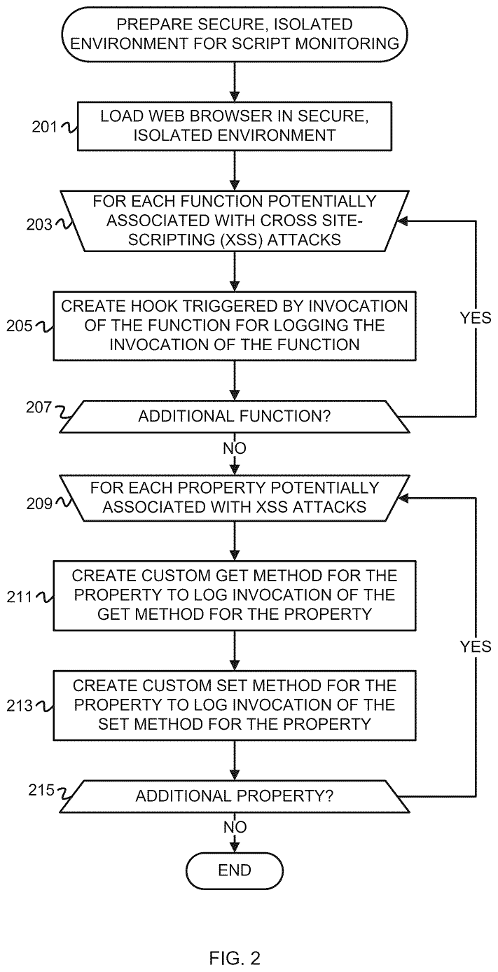

FIGS. 2-4 are flowcharts of example operations. The example operations are described with reference to a script sandboxing system (hereinafter “the system” for brevity) for consistency with FIG. 1 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for preparing a secure, isolated environment for script monitoring. Preparation of the environment is based on weaknesses or vulnerabilities exploited for injection attacks or XSS. Injection attack vulnerabilities typically exploit functions, web page properties, and/or combinations of functions and properties.

At block 201, the system loads a web browser in a secure, isolated environment. The secure, isolated environment may be a sandbox environment, for instance. The system may have also installed a library (e.g., an open-source library) that provides an API for controlling the web browser remotely. The system can create a plurality of tabs in the web browser via the API such that each web page provided by the system (as will be described below) can be allocated its own tab.

At block 203, the system begins iterating over a plurality of functions potentially associated with XSS attacks. The system has been configured with indications of functions, such as JavaScript functions, that have been determined (e.g., based on prior research/experimentation, based on domain knowledge, etc.) to be potentially invoked by malicious scripts for XSS. Examples of such functions include “eval( )”, “alert( )”, “fetch( )”, and “prompt( )”, among others.

At block 205, the system creates a hook that is triggered by invocation of the function for logging the invocation of the function. The system creates the hook such that invocations of the function are intercepted and trigger execution of custom code that logs/records the function invocation. As an example, the system can register a callback for the function, where invocation of the function triggers the callback and the callback logs/records the function invocation.

At block 207, the system determines if there is an additional function. If so, operations continue at block 203. Otherwise, operations continue at block 209.

At block 209, the system begins iterating over a plurality of properties potentially associated with XSS attacks. The system has been configured with indications of properties of browser-accessible objects, such as documents or other objects having DOM interfaces, that have been determined (e.g., based on prior research/experimentation, based on domain knowledge, etc.) as potentially being accessed by a malicious script for XSS. Examples of such properties include the properties “cookie,” “documentURI,” “baseURI,” and “referrer,” among others.

At block 211, the system creates a custom get method for the property to log the invocation of the property's get method. The system can update the existing get method defined for the property via JavaScript functions defined for modifying property descriptors. For instance, the system can call the function “getOwnPropertyDescriptor( )” for the property and its get( ) method to retrieve the getter function descriptor for the property and modify the existing definition of the getter function via “defineProperty( )”, where the getter function is modified to include a call to a logging function a logging function that logs the invocation of the getter for the property. For instance, the logging function can be defined by a logging service or logging functionality of the sandbox, where the system retrieves logs generated by the sandbox after sandbox monitoring of each script. Subsequent invocations of the getter for the property will thus result in invocation of the logging function included in the modified definition of the getter.

At block 213, the system creates a custom set method for the property to log the invocation of the set method for the property. Similar to creating the custom get method, the system can update the existing set method defined for the property via JavaScript functions defined for modifying property descriptors. For instance, the system can call the function “getOwnPropertyDescriptor( )” for the property and its set( ) method to retrieve the setter function descriptor for the property and modify the existing definition of the setter via “defineProperty( )”, where the setter is modified to include a call to a logging function that logs the invocation of the setter for the property. Subsequent invocations of the setter for the property will thus result in invocation of the logging function included in the modified definition of the setter.

At block 215, the system determines if there is an additional property. If so, operations continue at block 209. If not, operations are complete.

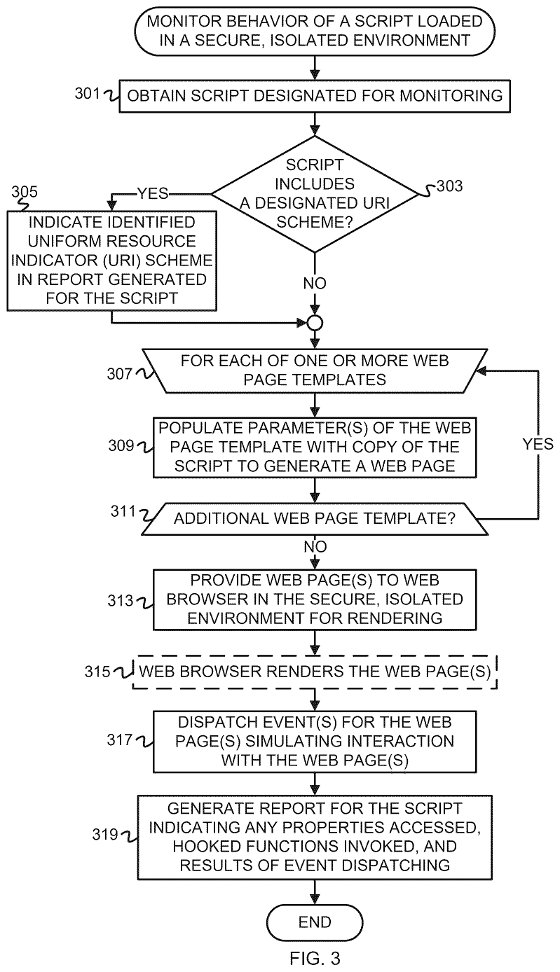

FIG. 3 is a flowchart of example operations for monitoring behavior of a script in a secure, isolated environment. The example operations assume that a secure, isolated environment, such as a sandbox, has been instantiated and prepared for monitoring script behavior. This includes instantiation of a web browser in the environment.

At block 301, the system obtains a script designated for monitoring. The system may obtain the script from input or submission (e.g., by a user), may retrieve the script from a queue of scripts designated for monitoring, or similar. The script may have been extracted from network traffic (e.g., network traffic detected by a cybersecurity appliance), such as based on identification of the HTML script tag (i.e., “<script>”) in a network traffic payload. The example operations assume that the script has at least been extracted from a corresponding script element (e.g., from between corresponding HTML script tags).

At block 303, the system determines if the script includes a designated URI scheme. The system has been configured with one or more indications of URI schemes determined to potentially be associated with malicious scripts for XSS. Examples of such URI schemes include “http”, “https”, and “javascript”, among others. The system can determine if the script matches any of one or more patterns defined for the one or more URI schemes, can search the script for the one or more URI schemes, etc. If the script includes a designated URI scheme, operations continue at block 305. If not, operations continue at block 307.

At block 305, the system indicates the identified URI scheme in a report generated for the script. The system adds to a report generated for the script an indication of the URI scheme identified in the script. The report may be generated as structured data (e.g., as a JSON file(s)).

At block 307, the system begins iterating over one or more web page templates. The system maintains or has access to one or more web page templates, each of which comprises one or more parameters to be populated with a script being monitored. For instance, each web page template may be an HTML template. The web page template(s) may include a variety of elements in which the script will be embedded, such as a variety of different HTML elements. An example of a web page template including two parameters to be populated by a script is as follows:

```
<head>
  <title>Test Template</title>
  <script>
    const userData1 = “{{param}}”;
    const userData2 = ‘{{param}}’;
  </script>
</head>
```

At block 309, the system populates each of one or more parameters of the web page template with a copy of the script. The system incorporates a copy of the script in each parameter included in the web page template. Populating each parameter of the web page template yields a web page at least comprising an HTML file that can be rendered by the web browser executing in the isolated environment.

At block 311, the system determines if there is an additional web page template. If there is an additional web page template, operations continue at block 307. If not, operations continue at block 313.

At block 313, the system provides the web page(s) generated from populating the web page template(s) to the web browser in the secure, isolated environment for rendering. For instance, the system can orchestrate loading of the web page(s) into the web browser for rendering, can submit the web page(s) to the web browser, etc.

At block 315, the web browser renders the web page(s). Block 315 is depicted in dashed lines to indicate that it is performed by a rendering engine of the web browser rather than the system. The web browser can render each web page in a respective tab, where the system may have created the web browser tabs during web browser instantiation (e.g., as described in reference to block 201 of FIG. 2) or may create the tabs via the API for controlling the web browser before providing the web page(s) to the web browser to be opened within a respective tab. Upon rendering of the web page(s), the script may execute. Any invocations of the hooked functions and access to the properties with modified getters and setters by the executing script will be captured and logged by the system.

At block 317, the system dispatches one or more events for each rendered web page to simulate interaction with the web page. Some malicious script behaviors may be triggered by interaction (e.g., by a user) with a web page in which the script is embedded. To account for this, the system dispatches one or more events that simulate interaction with the web page, such as mouse clicks, keypresses, scroll events, etc. The system can create one or more events of a corresponding one or more specified types with which the system was configured and dispatches each of the one or more events to the web page via a respective event dispatcher. As an example, the system can traverse the DOM corresponding to each of the rendered web pages. The system can readily access a DOM generated for each web page because the web pages were locally generated as a result of populating the web page templates. For each of at least a subset of the elements of the DOM identified from the traversal, the system dispatches one or more events of the corresponding one or more types targeting the element of the rendered web page in the web browser. The system can dispatch one or more events for each web page element or can dispatch events for a subset of the web page elements with certain types targeted by the system. Additionally, the event(s) dispatched by the system for a web page element may be dependent on the web page element type.

At block 319, the system generates a report for the script indicating any properties accessed during execution of the script, any of the hooked functions invoked during execution of the script, and results of event dispatching. The report may already indicate a URI scheme identified in the script if the analysis of the script at block 303 yielded identification of a designated URI scheme. The system includes in the report indications of any of the hooked functions that were invoked and triggered a corresponding hook (e.g., a corresponding callback function) created as described above. The system also includes in the report indications of any of the properties accessed via a respective getter and/or setter modified as described above. The system can display the report (e.g., via a user interface), store the report in a database for subsequent access, or otherwise make the report available for subsequent evaluation.

The example operations of FIG. 3 assume that the system obtains the script after it has already been extracted, such as from corresponding network traffic. In implementations, the system can extract scripts from network traffic designated for analysis, such as HTTP requests. For instance, the system can identify HTML script tags in network traffic payloads (e.g., in HTTP request bodies) and extract scripts from between corresponding HTML script tags. In addition to extracting scripts from HTML script tags, the system can also extract script-like content from HTTP request components, such as uniform resource locator (URL) parameters, uniform resource indicator (URI) path, and/or request bodies. Alternatively, or in addition, the system can extract script-like content from HTML attributes that can contain JavaScript, such as “src” and/or “href” attributes. For this case, the system can determine if HTML includes an “src” and/or “href” attribute, and if such an attribute is detected, extract the corresponding attribute value based on determining that the value includes the “javascript” keyword.

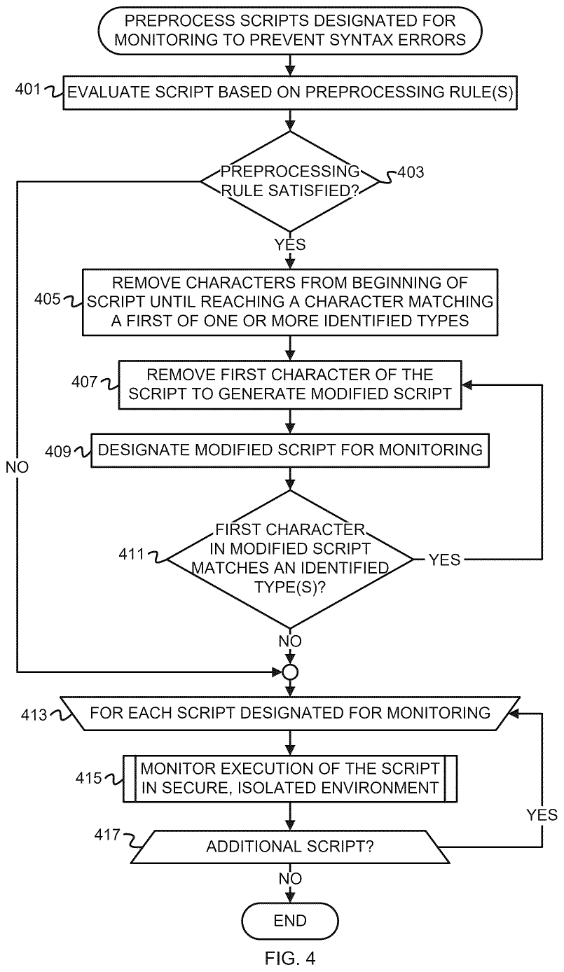

FIG. 4 is a flowchart of example operations for preprocessing scripts designated for monitoring to prevent syntax errors. Payloads comprising scripts may include partial statements not part of the script itself, which thus render the extracted portion comprising the script inexecutable as is. As an illustrative example, a web page vulnerable to XSS may comprise the element “<script>var username=“<USER_INPUT>”;</script>”. A malicious script of ““; alert(1);” injected into this web page to exploit the vulnerability would result in the element “<script>var username=””; alert(1);“;</script>”. However, the script ““; alert(1);” cannot be incorporated into a web page template for successful rendering as is because the special characters will result in a syntax error. The example operations of FIG. 4 can be employed to address such cases by preprocessing scripts to truncate script “prefixes,” or sequences of characters preceding the executable portion of a script, thereby removing these characters.

At block 401, the system evaluates the script based on one or more preprocessing rules. The preprocessing rule(s) comprise one or more rules for determining if a script should be truncated through removal of a prefix of the script. An example of such a rule is that a script should be preprocessed if it includes a prefix with one or more special characters or delimiters, such as a semicolon and/or a closing bracket, curly brace, and/or parenthesis (i.e., “]”, “}”, and/or “)”) without a corresponding opening bracket, curly brace, and/or parenthesis. The preprocessing rule(s) can be implemented with one or more patterns and/or indications of the special character(s) recognized by the system.

At block 403, the system determines if a preprocessing rule is satisfied. If a preprocessing rule is satisfied, operations continue at block 405. If not, operations continue at block 413.

At block 405, the system removes characters from the beginning of the script until reaching a character matching a first of one or more identified types. The one or more types are similar to the character types indicated in the preprocessing rules, such as closing brackets/braces/parenthesis, semicolons, or non-alphanumeric characters. To illustrate, for a script comprising the characters “foo);alert(‘document.domain’)”, assuming the closing parenthesis is an identified character type maintained by the system, the system removes the characters “foo” from the script. Subsequent operations are performed for the script having the initial character(s) removed (e.g., the script “); alert(‘document.domain’)” resulting from the previous example).

At block 407, the system removes the first character of the script to generate a modified script. The system removes the first character from the version of the script that remains after removing the initial character(s). For instance, with reference to the preceding example, the system removes the closing parenthesis from the script to generate the modified script “;alert(‘document.domain’)”.

At block 409, the system designates the modified script for monitoring. The system will monitor execution of each modified version of the script in the event that one or more modifications did not render the script executable. The system can store the modified version of the script in a data structure, write the modified version of the script to a file, etc.

At block 411, the system determines if the first character in the modified script matches a first of one or more identified types. The system compares the first character in the modified script to the identified type(s) referenced in block 405 and determines if there is a match. If the first character in the modified script matches any of the identified type(s), operations continue at block 407, where the system repeats the removal of the first character of the script and designation of the additional modified version of the script for monitoring. As an illustrative example, the system determines that the first character in the modified script “;alert(‘document.domain’)” matches one of the identified types and continues with removal of the semicolon. Otherwise, operations continue at block 413.

At block 413, the system begins iterating over each script designated for monitoring. The script(s) designated for monitoring can be the original, unmodified script if the preprocessing rule(s) was not satisfied. The script(s) designated for monitoring can also include one or more modified versions of the script having a character(s) removed therefrom.

At block 415, the system monitors execution of the script in a secure, isolated environment. The system monitors execution of the script as described above in reference to FIG. 3.

At block 417, the system determines if there is an additional script designated for monitoring. If there is an additional script designated for monitoring, such as an additional modified version of the script, operations continue at block 413. If not, operations are complete. The system can aggregate results of monitoring execution of each modified version of the script into a single report, where each results set is associated with an indication of the corresponding script (which may be a modified version of the original script) in the report, as different representations of the original script may yield different results.

### Variation

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in block 205 of FIG. 2 can be performed in parallel or concurrently across functions potentially associated with XSS attacks. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

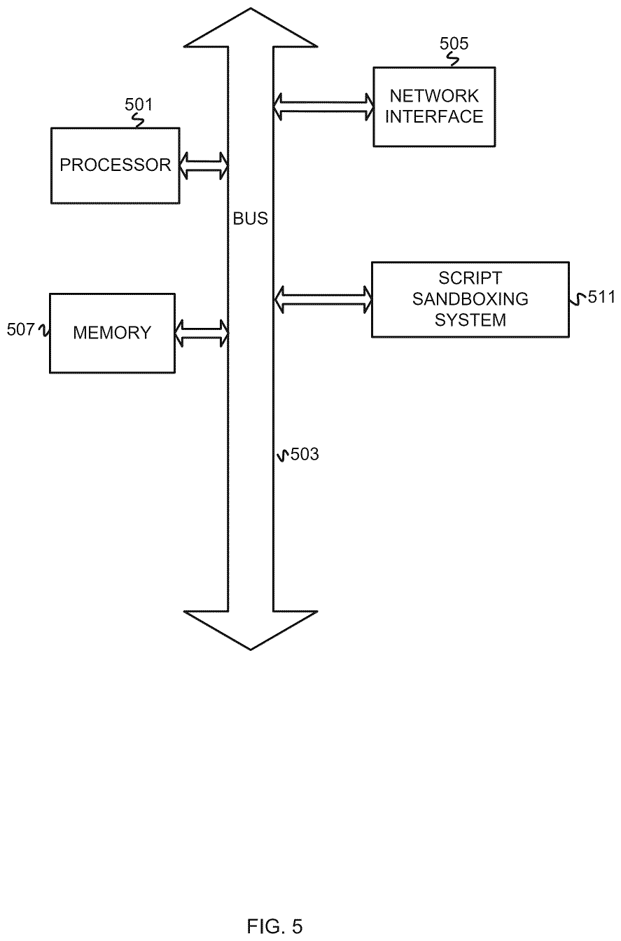

FIG. 5 depicts an example computer system with a script sandboxing system. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes script sandboxing system 511. The script sandboxing system 511 instantiates a sandboxed web browsing environment for secure and isolated execution of potentially malicious scripts. The script sandboxing system 511 generates web pages that can be rendered in the web browsing environment for securely monitoring behavior of a script by populating one or more web page templates with the script and providing the resulting web pages to the sandboxed web browsing environment for rendering. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

### TERMINOLOGY

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
loading a web browser in a sandbox;
creating a plurality of hooks for a plurality of functions, wherein the plurality of functions has been determined to be potentially associated with cross-site scripting (XSS) attacks, wherein invocation of any of the plurality of functions triggers a corresponding one of the plurality of hooks;
populating each of one or more web page templates with a script, wherein populating the one or more web page templates with the script generates one or more web pages;
providing the one or more web pages for rendering by the web browser in the sandbox; and
based on monitoring execution of the script in the sandbox, generating a report indicating behavior of the script, wherein the report indicating behavior of the script indicates any of the plurality of functions invoked during execution of the script that triggered a respective one of the plurality of hooks.

2. The method of claim 1, further comprising dispatching one or more events for each of one or more elements of the one or more web pages based on rendering of the one or more web pages, wherein each of the events simulates user interaction with the corresponding one of the one or more web pages, wherein the report indicating behavior of the script indicates behavior of the script based on dispatching the one or more events.

3. The method of claim 1, wherein populating the one or more web page templates to generate the one or more web pages comprises populating one or more HyperText Markup Language (HTML) templates to generate one or more HTML files.

4. The method of claim 3, wherein each of the one or more HTML templates comprises one or more placeholders for the script, and wherein populating the one or more HTML templates comprises replacing the one or more placeholders with the script in each of the one or more HTML templates.

5. The method of claim 1, wherein creating the plurality of hooks comprises registering a plurality of callback functions for the plurality of functions.

6. The method of claim 1, further comprising determining if the script comprises any of one or more uniform resource identifier (URI) schemes and indicating in the report if the script comprises any of the one or more URI schemes.

7. The method of claim 1, further comprising monitoring access to one or more properties of browser-accessible objects in a context of the one or more web pages, wherein the one or more properties have been determined to be potentially associated with XSS attacks, wherein generating the report comprises indicating in the report if any of the one or more properties of the one or more web pages were accessed during execution of the script.

8. The method of claim 7, further comprising:
for each of the one or more properties,
modifying a get function defined for the property, wherein modifying the get function comprises modifying the get function to log invocations of the get function; and
modifying a set function defined for the property, wherein modifying the set function comprises modifying the set function to log invocations of the set function,
wherein the report indicating behavior of the script indicates if the script invoked the get function or the set function for the property.

9. The method of claim 1, further comprising modifying the script to generate one or more modified scripts based on determining that the script begins with one or more special characters, wherein modifying the script removes the one or more special characters from the script, wherein populating the one or more web page templates comprises, for each of the one or more modified scripts, populating each of the one or more web page templates with the modified script.

10. The method of claim 9, wherein modifying the script comprises, at each of one or more iterations,
based on determining that a first character of the script matches one of a set of special characters, removing the first character from the script, wherein removing the first character from the script creates a corresponding one of the one or more modified scripts; and
providing the script with the first character removed for a next of the one or more iterations.

11. One or more non-transitory machine-readable media having program code stored thereon for monitoring execution of a script in an isolated environment for behavior associated with cross-site scripting (XSS) attacks, the program code comprising instructions to:
instantiate a web browser in the isolated environment;
create a plurality of hooks for a corresponding plurality of functions potentially associated with XSS attacks;
generate a plurality of web pages for monitoring behavior of the script, wherein the instructions to generate the plurality of web pages comprise instructions to, for each web page template of a plurality of web page templates, populate each of one or more placeholders of the web page template with the script, wherein population of the one or more placeholders of the web page template with the script generates a corresponding one of the plurality of web pages;
load the plurality of web pages in the isolated environment;
monitor execution of the script in the isolated environment based on rendering of each of the plurality of web pages by the web browser; and
generate results of monitored execution of the script in the isolated environment, wherein the results of monitored execution of the script indicate whether any of the plurality of functions were invoked based on triggering of any of the plurality of hooks.

12. The non-transitory machine-readable media of claim 11, wherein the program code further comprises instructions to dispatch one or more events for at least a first web page of the plurality of web pages based on rendering of the first web page, wherein each of the one or more events simulates user interaction with the first web page, wherein the results of monitored execution of the script indicate behavior of the script based on dispatching of the one or more events.

13. The non-transitory machine-readable media of claim 11, wherein the plurality of web page templates comprises a plurality of HyperText Markup Language (HTML) templates, wherein the instructions to populate each of one or more placeholders of the web page template with the script comprise instructions to populate one or more placeholders of a first of the plurality of HTML templates with the script to generate an HTML file.

14. The non-transitory machine-readable media of claim 11, wherein the program code further comprises instructions to:
determine whether the script comprises any of one or more uniform resource identifier (URI) schemes and indicate in the results of monitored execution of the script whether the script comprises any of the one or more URI schemes; and
monitor access by the script to one or more properties of browser-accessible objects in a context of the plurality of web pages, wherein the one or more properties have been determined to be potentially associated with XSS attacks, wherein the results of monitored execution of the script indicate if any of the one or more properties of a corresponding one of the plurality of web pages were accessed during execution of the script.

15. An apparatus comprising:
a processor; and
a machine-readable medium having instructions stored thereon that are executable by the processor to cause the apparatus to,
load a web browser in an isolated environment;
create a plurality of hooks for a plurality of functions, wherein each of the plurality of functions has been determined to be potentially associated with cross-site scripting (XSS) attacks;
for each of one or more web page templates, populate each of one or more parameters of the web page template with a script, wherein population of the one or more web page templates generates one or more web pages that comprise the script;
provide the one or more web pages for rendering by the web browser in the isolated environment;
monitor execution of the script in the isolated environment; and
generate a report indicating results of execution of the script in the isolated environment, wherein the report indicating behavior of the script indicates if any of the plurality of functions were invoked during execution of the script and triggered a corresponding one of the plurality of hooks.

16. The apparatus of claim 15, further comprising instructions executable by the processor to cause the apparatus to dispatch one or more events for at least a first of the one or more web pages based on rendering of the one or more web pages, wherein each of the one or more events simulates user interaction with the first web page, wherein the report indicating behavior of the script indicates behavior of the script based on dispatch of the one or more events.

17. The apparatus of claim 15, wherein the one or more web page templates comprise one or more HyperText Markup Language (HTML) templates, wherein the executable by the processor to cause the apparatus to populate each of the one or more parameters of the web page template with the script comprise instructions executable by the processor to cause the apparatus to populate each of one or more parameters of a corresponding one of the one or more HTML templates with the script.

18. The apparatus of claim 15, further comprising instructions executable by the processor to cause the apparatus to determine if the script comprises any of one or more uniform resource identifier (URI) schemes and include in the report an indication of if the script comprises any of the one or more URI schemes.

19. The apparatus of claim 15, further comprising instructions executable by the processor to cause the apparatus to monitor access by the script to one or more properties of browser-accessible objects in a context of the one or more web pages, wherein the one or more properties have been determined to be potentially associated with XSS attacks, wherein the instructions executable by the processor to cause the apparatus to generate the report comprise instructions executable by the processor to cause the apparatus to indicate in the report if any of the one or more properties of a corresponding one of the one or more web pages were accessed during execution of the script.

20. The apparatus of claim 15, further comprising instructions executable by the processor to cause the apparatus to modify the script to generate one or more modified scripts based on a determination that the script begins with one or more special characters, wherein the instructions executable by the processor to cause the apparatus to modify the script comprise instructions executable by the processor to cause the apparatus to remove each of the one or more special characters from the script, wherein the instructions executable by the processor to cause the apparatus to populate each of the one or more parameters of the web page templates with the script comprise instructions executable by the processor to cause the apparatus to, for each of the one or more modified scripts, populate each of the one or more parameters of the web page template with the modified script.
